(19) United States
(12) Patent Application Publication
(10) Pub. No.: US 2006/0213071 A1
(43) Pub. Date: Sep. 28, 2006

(54) Automatic measuring device for measuring the dimensions of a tool for a machine tool

(76) Inventors: Jacques Thibaut, Vaudry (FR); Christophe Thibaut, Vire (FR)

Correspondence Address: Gary M Cohen;Strafford Building Number Three, Suite 300, 125 Strafford Avenue, Wayne, PA, 19087-3318, US

(21) Appl. No.: 10/550,779

(22) PCT Filed: Mar. 4, 2004
(86) PCT No.: PCT/FR04/00506

§ 371 Date: Sep. 27, 2005

(30) Foreign Application Priority Data
Mar. 31, 2003 (FR) 03/03917

(51) Int. Cl. G01B 5/20

(52) U.S. Cl. 33/501.18

(57) ABSTRACT

The present invention relates to an automatic measuring device for measuring the dimensions of a tool for a machine tool comprising a spindle (10) for receiving a tool (2) which is capable of being moved in order to interact with the device (1) in order to deduce, according to a measuring system specific to said spindle (10), the dimensions of the tool (2), characterized in that it consists of a bar (3) made of a material having highly elastic properties, one of these ends of which is fixedly attached to a yoke attached to a fixed frame (5) and its opposite free end is in contact with two detectors (6 and 7) placed perpendicular to one another and to a yoke (8) capable of sliding on the flexible bar (3) that is overhung by a platform (9) on which said tool (2) to be measured is capable of resting.

The present invention relates to an automatic measuring device for measuring the dimensions of a tool for a machine tool.

Thanks to the presence of a magazine comprising all the tools necessary for the machining of a workpiece, machine tools can be used fully automatically to carry out the machining of a workpiece, such as for example a kitchen or bathroom worktop.

However, in order to sequence all the machining operations automatically, the machine tool has first to measure and store the exact dimensions of all the tools stored in its magazine.

Devices are already known in the prior art that allow such an automatic measurement of the dimensions of each tool in which the machine spindle fitted with a tool comes to interact with the device arranged on the machine tool in order to deduce, depending on its measurement system specific to its spindle, the dimensions of the tool.

One of these devices consists, for example, of two separate tracers, respectively one axial and one radial, the machine with the tool to be measured in its spindle first comes to rest the bottom face of the tool on the axial tracer to measure its length, then secondly rests the outer face on its radial tracer to measure its diameter.

Such a measurement device, although accurate, is extremely costly and sensitive to impacts. Furthermore, it needs to be situated in a protected location and sheltered from machining spray.

Another known device consists in arranging a laser beam on the machine. The machine determines and memorizes the dimensions of the tool when the latter cuts the laser beam with the bottom face or its outer face corresponding respectively to the determination of the length and the diameter of the tool.

The major disadvantage of such a device lies in the fact that it is unsuitable for working stone, of which kitchen tops are made for example, because of the water and mud spray which may divert or obstruct the laser beam.

The object of the invention is to propose an automatic measuring device for measuring the dimensions of a tool which remedies some or all of the aforementioned disadvantages.

Accordingly, the subject of the present invention is an automatic measuring device for measuring the dimensions of a tool for a machine tool comprising a spindle for receiving a tool which is capable of being moved in order to interact with the device in order to deduce, according to a measuring system specific to said spindle, the dimensions of the tool, characterized in that it consists of a bar made of a material having highly elastic properties, one of these ends of which is fixedly attached to a yoke attached to a fixed frame and its opposite free end is in contact with two detectors placed perpendicular to one another and to a yoke capable of sliding on the flexible bar that is overhung by a platform on which said tool to be measured is capable of resting.

According to some worthwhile provisions of the invention:
the bar is made of an elastic steel and has a square cross section,
the detectors are micrometric end-of-travel detectors (having a high degree of protection against external attack), one of which is placed vertically in order to determine the length and the other is placed horizontally in order to determine the diameter,
each of the detectors is connected to a measuring system specific to the positions of the spindle thus making it possible, when they break contact with the bar, to deduce the dimensions of the tool,
the platform is provided with a beveled edge.

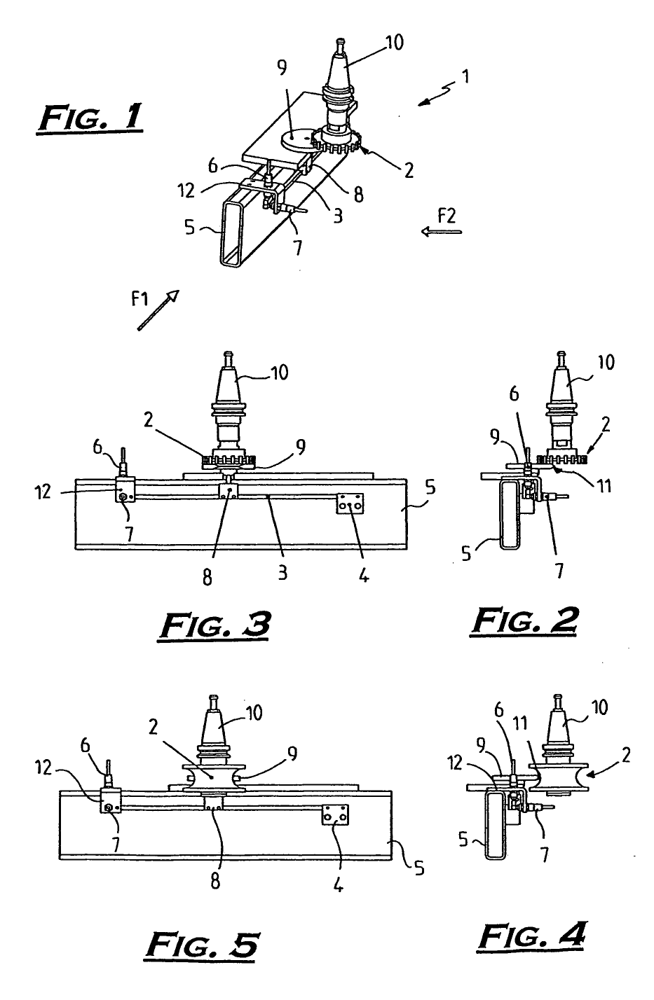

The aforementioned features of the invention, and others, will emerge more clearly on reading the following description of an exemplary embodiment, with reference to the appended drawings in which:
FIG. 1 is a view in perspective of an automatic measuring device for measuring the dimensions of a tool for a machine tool according to the present invention,
FIGS. 2 and 3 are views respectively along the arrows F1 and F2 of FIG. 1, illustrating the measurement of the length of a tool, and
FIGS. 4 and 5 are views similar to FIGS. 2 and 3 illustrating the cutting tool in a position whereby the device can deduce the diameter of a cutting tool.

FIGS. 1 to 5 show an automatic measuring device 1 for measuring the dimensions of a cutting tool 2 for a machine tool, particularly numerically controlled, intended to be positioned, for example, on the side of the machine's tool magazine.

According to the present invention, this measuring device 1 consists of a bar 3 made of a material having highly elastic properties, one of these ends of which is fixedly attached to a yoke 4 attached to a fixed frame 5 and its opposite free end is in contact with two detectors 6 and 7 placed perpendicular to one another and a yoke 8 capable of sliding on the flexible bar 3 that is overhung by a platform 9 on which the tool 2 to be measured is capable of resting, mounted on a spindle 10 of the machine tool.

The bar 3 is advantageously made of an elastic steel and has a square cross section allowing a good contact with the detectors 6 and 7, as explained below.

According to a preferred embodiment, the platform 9 is provided with a beveled edge 11 (as can be seen in FIGS. 2 and 4) in order to ensure an appropriate measurement of the diameter for tools 2 having various shapes such as, for example, an external concave profile (FIGS. 4 and 5).

It should also be noted that the detectors 6 and 7 are advantageously micrometric end-of-travel detectors one of which 6 is placed vertically in order to determine the length and the other 7 is placed horizontally in order to determine the diameter, as explained in greater detail in the rest of the description. These detectors 6 and 7 are attached, as shown in FIGS. 2 and 4, to a flange 12 that is generally L-shaped, made fixedly attached to the frame 5 in order to ensure a contact with the bar 3 only at their ends.

Each of these detectors 6 and 7 is connected to a conventional specific system (not shown) for measuring the positions of the spindle 10 thus making it possible, when they break contact with the bar 3, to deduce the dimensions of the tool 2.

It can be easily understood that in order to measure the length of a tool 2, it is sufficient for the machine furnished with a tool in its spindle 10, to come and rest the bottom face of the tool 2 on the top face of the platform 9 of the yoke 8 thus causing the bar 3 to flex which releases the vertical end-of-travel detector 6 in order to deduce, according to the reference positions of the spindle 10, and register the length of the tool 2.

In a similar manner, the external diameter of a tool 2 is measured by placing the outside of the tool 2 in contact with the bevel 11 of the platform 9 causing a lateral flexing of the bar 3 releasing the horizontal end-of-travel detector 7 in order to deduce the diameter of the tool 2.

It will be noted that the precision of the measurement may be optimized by moving the movable yoke 8 provided with the platform 9 and distancing it as far as possible from the free end of the bar 3 where the detectors 6 and 7 are situated. Thus, the greater the amplitude of the bar 3, the more precise the measurement.

Such an automatic measuring device has the following advantages:
1 is not fragile, unlike the solutions of the prior art and also operates irrespective of the environment, that is wet or dusty,
2 is economical to purchase and maintain,
3 is reliable due to the simplicity of its design and the components used.

Furthermore, in the event of an error by the operator or the machine, only the bar can be damaged. This is easily and rapidly replaceable and at less cost.

Although the invention has been described with reference to a particular embodiment, it covers all the technical equivalents of the methods described.

1. An automatic measuring device for measuring the dimensions of a tool for a machine tool comprising a spindle (10) for receiving a tool (2) which is capable of being moved in order to interact with the device (1) in order to deduce, according to a measuring system specific to said spindle (10), the dimensions of the tool (2), characterized in that it consists of a bar (3) made of a material having highly elastic properties, one of these ends of which is fixedly attached to a yoke attached to a fixed frame (5) and its opposite free end is in contact with two detectors (6 and 7) placed perpendicular to one another and to a yoke (8) capable of sliding on the flexible bar (3) that is overhung by a platform (9) on which said tool (2) to be measured is capable of resting.

2. The automatic measuring device for measuring the dimensions of a tool as claimed in claim 1, characterized in that the bar (3) is made of an elastic steel and has a square cross section.

3. The automatic measuring device for measuring the dimensions of a tool as claimed in either one of the preceding claims, characterized in that the detectors (6 and 7) are micrometric end-of-travel detectors, one of which (6) is placed vertically in order to determine the length and the other (7) is placed horizontally in order to determine the diameter.

4. The automatic measuring device for measuring the dimensions of a tool as claimed in claim 3, characterized in that each of the detectors (6 and 7) is connected to a measuring system specific to the positions of the spindle (10) thus making it possible, when they break contact with the bar (3), to deduce the dimensions of the tool (2).

5. The automatic measuring device for measuring the dimensions of a tool as claimed in any one of the preceding claims, characterized in that the platform (9) is provided with a beveled edge (11).
